(19) United States
(12) Patent Application Publication
(10) Pub. No.: US 2002/0077182 A1
(43) Pub. Date: Jun. 20, 2002

(54) Interactive computer games

(76) Inventors: Arthur Swanberg, Westport, CT (US); Ethan Rappaport, Orange, CT (US)

Correspondence Address: George R. Pettit, Connolly Bove Lodge & Hutz LLP, P.O. Box 19088, Washington, DC, 20036-0088, US

(21) Appl. No.: 09/905,888

(22) Filed: Jul. 17, 2001

Related U.S. Application Data
(63) Continuation-in-part of application No. 09/737,772, filed on Dec. 18, 2000.

(51) Int. Cl. A63F 13/00

(52) U.S. Cl. 463/43

(57) ABSTRACT

A computer implemented game which uses a smart card for obtaining additional game features. The computer software running on the computing system includes a portion of code which is generally locked from use. The locked portion of code represents additional characters, levels of play, and other game playing enhancements which may be played in the game. Unlocking of the code set occurs when a user has the appropriate smart card representing the character. Alternatively, the game playing computer software may receive installable code from the smart card which defines additional characters, levels of play, and other game playing enhancements for the user.

### RELATED PATENT APPLICATIONS

The present application is a continuation-in-part of U.S. patent application Ser. No. 09/737,772

### BACKGROUND OF THE INVENTION

The present invention relates to computer implemented interactive games which derive at least a portion of their game functions from an external smart card. Specifically, a system is disclosed which permits external smart cards to be used for increasing the game functionality.

Computer implemented games are increasingly popular. Early versions of these games permit a user to play a game where the player skill is matched against the game rules. It has been proposed in the related U.S. patent application, hereby incorporated by reference, to permit games to be played which are based on purchasable trading cards in the form of a smart card. Smart cards are provided in two versions. The first version is a microprocessor based circuit embedded in a small card which is currently used in various banking applications. Users can exchange credit and debit information with a central banking location as part of the process for transferring funds into and out of a bank account. The second version is a memory based circuit embedded in a small card containing security features which are currently used in prepaid telephone applications.

In accordance with the related patent application, it has been proposed to use the smart card as a trading card which contains information necessary to play a game on a computer. The game information is read through a reader connected to a personal computing system. Additional trading cards may be collected, where the games functionality is increased or changed depending on the new trading card. In a character based game, additional characters for playing the game may be acquired by purchasing additional trading cards.

The foregoing system can be either locally based or an internet based system. With the internet based game system, the game is played with information derived from a website controlled by the trading card vendor. In a sports game, it is possible to acquire individual team members by obtaining additional trading cards pertaining to a particular personality. Each new trading card will result in a new player being added to the game until the user has assembled a full team. Scoring depends on the relative statistics of each team member.

The use of the smart trading card provides still other advantages in computer game execution. The present invention is directed to further improvements to computer game programs using the smart trading card.

### SUMMARY OF INVENTION

A computer implemented game is provided wherein game software running on the computer accesses an external smart card to obtain data related to one of the characters in the game or a portion of game play. The data read from the smart card unlocks executable code in the computer program relating to the character or portion of game play. Alternatively, or additionally, the smart card can provide installable code for the computer game, including image files, audio files or attributes pertaining to the character or portion of game play.

The smart card may also enhance the use of the card in an internet based game. When a game is to be played using information obtained from a website as part of the game, the smart card may be read by the local computer system executing the game playing computer code to obtain an electronic address. The electronic address is used by the computing system browser software to automatically access the appropriate website.

Computer instructions may be provided which, in response to a command received through a graphical interface by the user, retrieve information from the smart card and use it to either locate a website which is to be accessed by the computer's browser program, or to execute a local computer program which is identified from data retrieved from the smart card. If the identified computer program is on the local computer reading the smart card, the computer begins execution. As a variation thereof, in the event the computer program is not on the computer, additional code may be executed to retrieve the program from a remote computer via a connected network.

Still other objects and advantages of the present invention will become readily apparent by those skilled in the art from the following detailed description, wherein it is shown and described in preferred embodiments of the invention, simply by way of illustration of the best mode contemplated of carrying out the invention. As will be realized the invention is capable of other and different embodiments, and its several details are capable of modifications in various obvious respects, without departing from the invention. Accordingly, the description is to be regarded as illustrative in nature and not as restrictive.

### DESCRIPTION OF THE FIGURES

FIG. 1 illustrates a computing system for playing a computer implemented game;

FIG. 2 illustrates the layout of characters which are displayed on monitor 12 while playing the computer game;

FIG. 3 illustrates the computer programming steps executed by the computing system for increasing game functionality based on smart card data;

FIG. 4 illustrates an internet based computer game which uses smart card information to locate the appropriate website for playing a game.

FIG. 5 illustrates the computer programming steps executed by the computing system of FIG. 4.

FIG. 6 illustrates an enhanced version of the system illustrated in FIGS. 4 and 5.

### DESCRIPTION OF THE PREFERRED EMBODIMENT

Referring now to FIG. 1, a computing system for playing computer implemented games is shown. The computing system may be a standard personal computer having a keyboard 10, processor 9 and a monitor 12. Game software is loaded into the computer 9 memory from a disk 8 which may be a CD-ROM, floppy disk or game cartridge containing game software. Alternatively, a computer game console for playing computer implemented games may be used instead of a personal computer which typically would not include a keyboard or mouse/pointer device. As used herein, computing system means either type of game playing hardwaves and any equivalent thereof. The computer processor 9 operates in response to commands from the keyboard 10 or from point and click controls provided by the pointing device or mouse 16. Computer 9 is also connected to an internet connection 16, permitting the game software to be played in conjunction with a website maintained by the game software vendor.

The computing system of FIG. 1 also includes a smart card reader 11 which receives a smart card 10 containing data related to the game software being executed on the computing system. The reader is an existing smart card reader, such as the ACR cybermouse, GEM+GCR410, or another well-known readers. The reader may be connected to a USB port or a serial (COM) port combined with either the keyboard port, or mouse port of the processor 9. The reader has the ability to read and write information to the smart card 10 using the standard protocol associated with a smart card.

The smart card 10 serves as a trading card for hobbyists who play the computer game. In accordance with one embodiment of the invention, the smart card may contain data finding a character to be added to the game. Printed on the smart card 10 may be a picture 15 identifying the character, along with some basic information concerning the character. The smart card 10 contains information stored in its memory which will be accessed by the processor 9 while executing the game software 8.

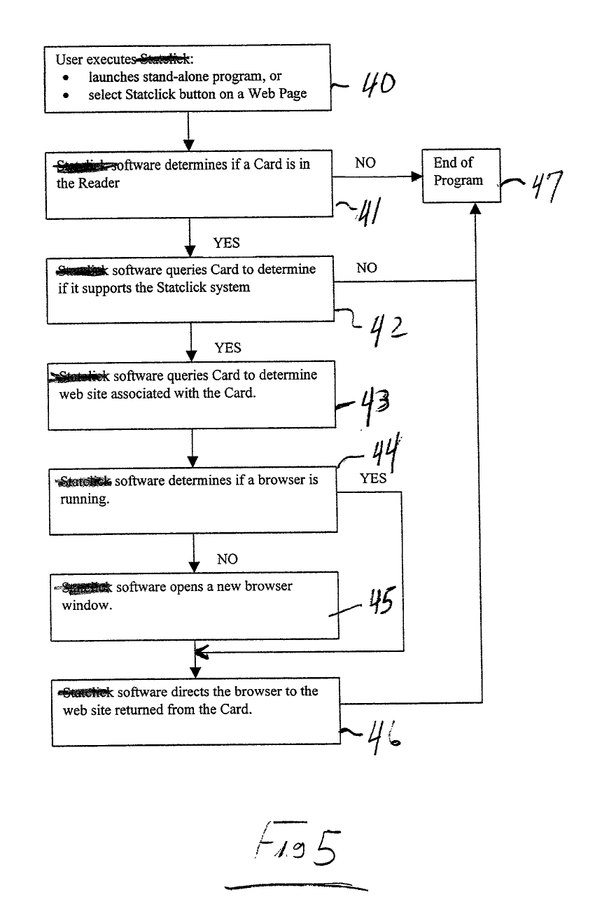

The addition of characters, new game portions, or cheat codes to the game being played can be based on one of two techniques which requires data to be read from the smart card 10. In the first, which will be explained in greater detail with respect to FIG. 4, data is stored in the memory which unlocks the section of code in the game software 8, permitting access to all of the information necessary to add the character to the game. The unlock code may be a special byte sequence which is recognized by the computing system executing the game software. The disadvantage of this feature is that it requires knowledge of all future characters in advance of issuing any smart trading cards 10, as all characters would necessarily have to be provided on a restrictive basis in the code of the game software 8 before the software 8 is issued to the user.

As another approach to be explained in greater detail, the game software is written open-ended, so that characters may be installed from code stored in the smart trading card 10 permitting new characters to be added at any time in the future.

In implementing the unlock key for accessing code dedicated to a specific character represented by the smart trading card 10, some of the character abilities and levels of game play may also be contained in the code which is to be unlocked. Thus, the game software 8 when reading the smart card 10 will make the character and a particular level of game play available for the user.

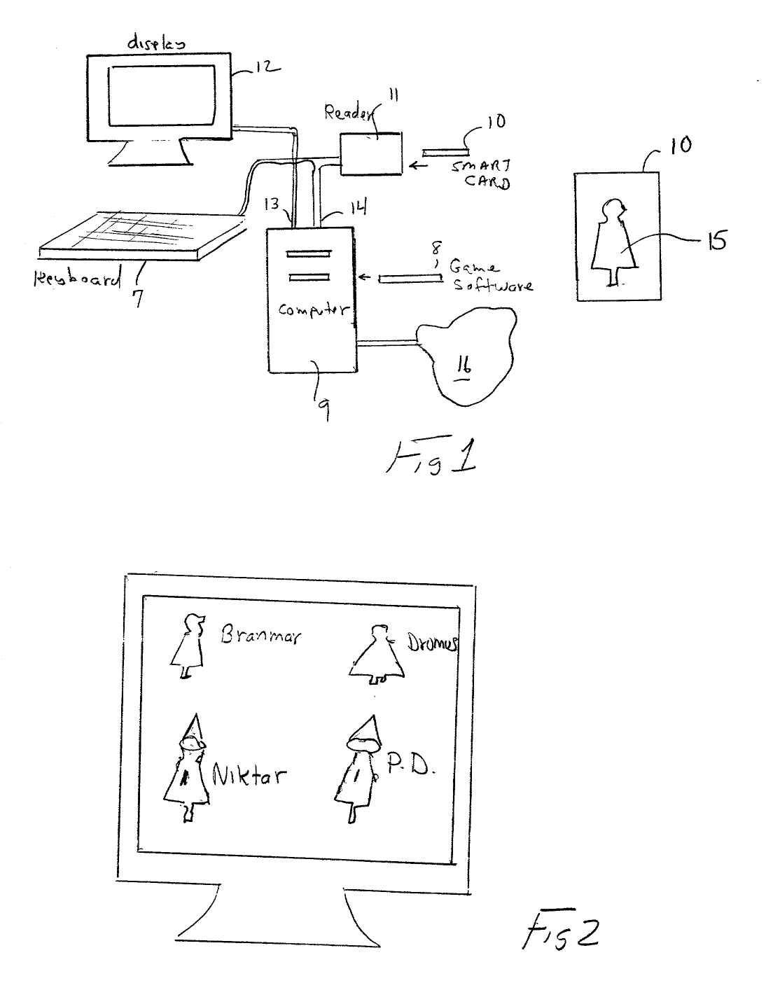

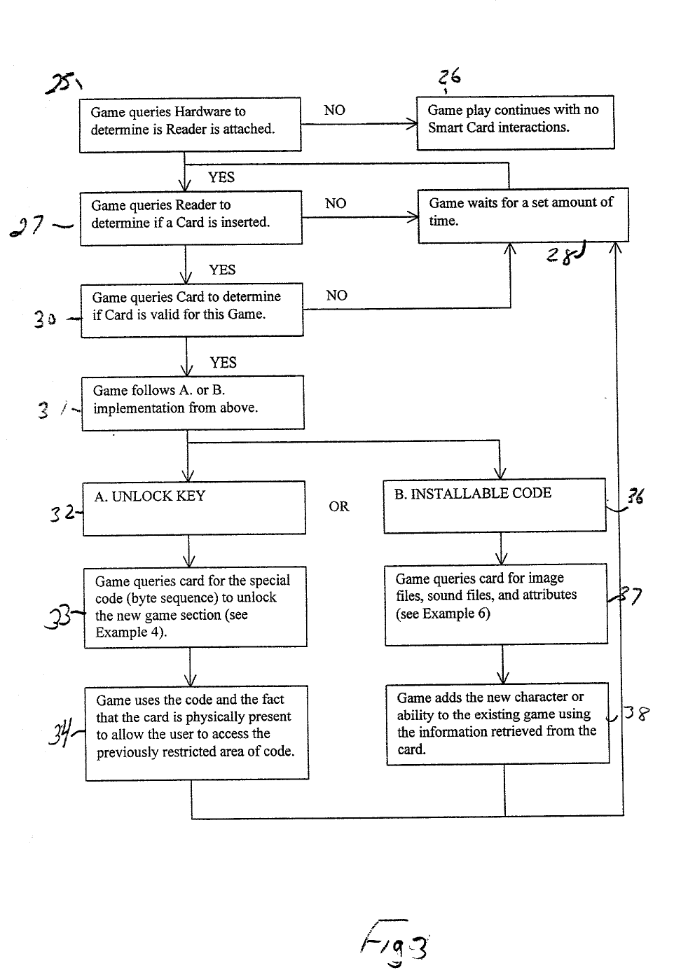

FIG. 2 illustrates the role playing game of Wizard's Battle Game wherein several different wizards, identified as Branmar, Niktar, and Dromus, and one practice dummy, are displayed on the monitor 12. Each of the characters can only be displayed when a corresponding smart trading card 10 has been inserted in reader 11, and read during execution of the game software 8. The picture appearing on the display monitor 12 may be identical to that shown on the smart trading card 10. Additionally, each of the smart trading cards 10 includes the name of the wizard.

The smart card 10 may, instead of providing an unlocking code through the game software 8, include new installable code that interacts with existing code of the game software 8 to add a new character, or ability, to an existing character. For example, in a role playing game being played on the computer system 9, the game software 8 during execution will read the contents of the smart trading card 10 through the reader 11, and use the code obtained including image files, sound files, character actions and abilities to introduce a new area of game play to the existing game. In the wizards game, several images such as an adult body, a child body, an adult arm up and an adult arm down, a child arm up, a child arm down, and a full wizard view will be downloaded from the smart trading card 10. The wizards as part of the game scheme have basic spells they can cast. A spell includes the name of the spell, two magic words to cast the spell, and an image of an animal representing that the spell that has been cast. Additionally, a score necessary to have the wizard mature to adulthood can be loaded from the smart trading card 10.

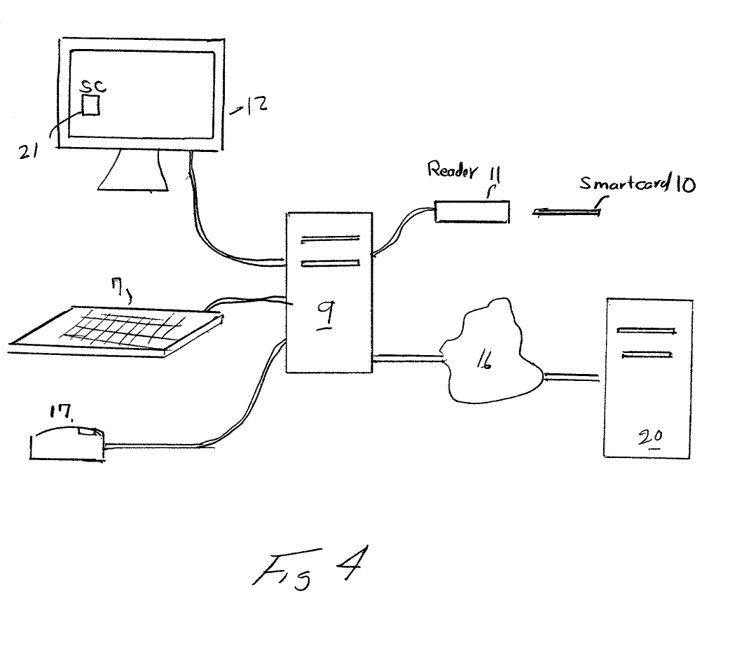

The execution sequence by the processor 9 executing the code contained in the game software 8 is illustrated more specifically in FIG. 3.

Referring now to FIG. 3, the process executed by the processor 9 is shown. As part of the executable code sequence for the game software 8, the software execution queries whether or not the reader is attached to a port of processor 9 in step 25. In the event there has been no reader detected, game play continues in step 26 without the benefit of any smart card data.

If a reader is connected, the reader is again queried in step 27 to determine if a smart card is present. If not, the system waits a period of time 28 and periodically inquires as to whether the reader and card are available for reading.

The game software execution sequence queries the smart trading card in step 30 to determine if the card is valid for the game being played. If the card is valid, the execution sequence follows one of two paths, A or B, depending on the determination of which type of implementation has been used.

In the event that the card contains an unlock key as determined in step 32, the executed code of the game software queries the card for the unlock code in step 33 to unlock a section of code contained in a computer game program 8. The unlock code is then used by the game program 8 to permit access to previously restricted areas of code contained in the game program 8.

In the event that the invention is implemented using installable codes, as determined in step 36, the execution of the game software results in the smart card being queried for image files, sound files, and any attributes which are associated with a player or character in the game in step 37. The new information relating to the game is stored in a RAM of the processor 9 in step 38, and is used to play the game using this information.

Thus, it can be seen that by using the outside smart card, stand alone computer implemented games may be played and additional features used depending on the user's possession of a given smart card. Additional smart cards may be collected and used to make the game more interesting to the user.

FIG. 4 illustrates the use of the smart card for enhancing the operation of a computer implemented game which relies upon accessing a remote computer via a network 19. The computer implemented game is played on a computing system comprising a processor 9, monitor 12, input devices 7 (keyboard) and 17 (pointing device/mouse). Additionally, a card reader 11 is connected to a COM port or USB port of the processor 9 for reading a smart card 10. In order to play the interactive game, software is executed by processor 9. Other code such as a browser plug in, necessary for playing the game resides on a remote server 20 as part of a website maintained by the game vendor. The additional code is retrieved via a network connection 17 to a network 16, such as the Internet, and downloaded to the internal memory of computing system.

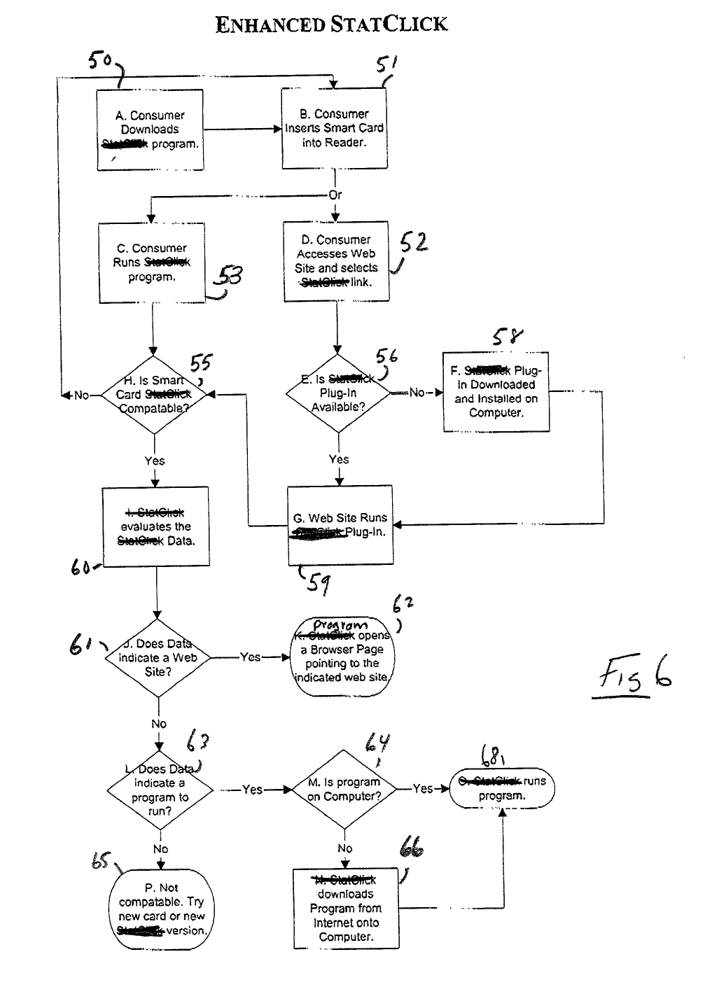

In order to initiate a session with the manufacturer's remote terminal, which may be a website running on remote server 20, the user selects an icon 21 displayed by the graphical interface of the computing system using the pointing device/mouse 17. As will now be explained in greater detail with respect to FIG. 5, selection of the icon 21 using the point and click feature of the graphical interface initiates a connection between a browser application running on the processor 9 and the server 20 application containing the manufacturer's website.

The game software 8 begins execution in step 40 by clicking on the icon 24 presented from the game software 8. The code contained in the game software determines in step 41 if a smart card 10 is in the reader 11. If the card returns an indication that it supports the software 8 in step 42, the software 8 determines a remote computer application location, such as a website address, from reading data on the smart card in step 43. The executed game program code determines in step 44 if the browser application of the computing system is running. If not, the computer software execution opens the browser application in step 45. The continued execution of the game software 8 results in the browser accessing the website using the website address retrieved from the smart card 11 in step 46. Once the website is acquired, the instruction set is completed in step 47.

While the foregoing implementation is directed to enhance game playing using an internet connection, the system may have other non-game applications, where users gain access to other products and services using the foregoing invention. For instance, users can be directed to other websites unrelated to playing a game.

The foregoing executable code may be initially downloaded from a manufacturer's website, to the hard disk of the computer processor 9. Additionally, the software may be available as a browser plug in-in, for the particular browser application run on the computing system processor 9.

An enhanced version of the foregoing system for reading data from the smart card and using it in the playing of a computer game, is illustrated with respect to FIG. 6. The program constituting the enhancement may be obtained by the user as a separate executable game software contained on a disk in step 50. The smart card is inserted into the smart card reader in step 51, and, if the computer program is determined in step 50 to be present, the user runs the program in step 53 by clicking on an icon using a graphical interface running on the computer.

Alternatively, if the program is not otherwise available, it may be downloaded via the Internet in step 52. The user may manually access the website containing the computer program and select an appropriate link for downloading the computer program. A decision is determined in step 56 that the downloadable program is available locally as a plug-in. If it is not available locally, the plug-in is downloaded in step 58 and installed on the computer. The running of the plug-in in step 59 on the local game playing computer makes the required program code available to the user.

Once the program is available, the smart card is interrogated and, in accordance with decision block 55, a determination is made as to whether the data on the smart card is compatible with the program being executed. If it is, the required data is evaluated from the smart card in step 60.

The data obtained from the smart card may represent a website address as determined in step 61. If so, the program executes code for opening a browser application running on the computer in step 62, pointing to the website which was identified in the smart card data. Thus, the user is fully connected with the website for playing the game.

As an alternative, the data recovered from the smart card may indicate a program to be run as determined in step 63. In the event that the data obtained from the smart card fails to identify a website address or a program to be run, an indication is given to the user in step 65 that the smart card is not compatible with the computer code. If the program is presently stored on the computer, as determined from step 64, it is run by the downloaded code in step 68. In the event the computer program is not available on the computer, step 66 accesses an address also over the Internet to obtain the computer program which is to be executed.

The foregoing systems permit holds of a smart card to access all required programming related to a game or other function using a single graphical interface command. Thus, when the command is executed, the system will access the smart card to learn the location of any necessary computer programs to run. Further computer instructions/programs are then retrieved and loaded into the user's computer permitting game play or other function to commence.

The foregoing description of the invention illustrates and describes the present invention. Additionally, the disclosure shows and describes only the preferred embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A computer implemented game comprising:
computing system for playing a computer game;
a game playing computer program executed in said computing system, said game program including interactive characters;
a smart card reader connected to said computing system which is periodically queried to determine the presence of a smart card; and
a smart card having stored therein data pertaining to a feature of a game being played; said smart card data being read by said game playing software which is used to enhance said game being played.

2. The computer implemented game according to claim 1 wherein said smart card data is used in said computing system to unlock executable code in said computer program which permits said feature of the game to be played.

3. The computer implemented game according to claim 1 wherein said smart card data provides installable code for said computing system which permits said feature of the game to be played with said one character.

4. The computer implemented game according to claim 2 wherein said smart card data for unlocking said executable code is a special byte sequence recognized by said computer system running said game program whereby previously unaccessible game program executable code is run with said game program.

5. The computer implemented game according to claim 3 wherein said installable code includes an image file for representing a character.

6. The computer implemented game according to claim 3 wherein said installable code includes attributes pertaining to a game character.

7. The computer implemented game according to claim 3 wherein said installable code constitutes a sound file relating to a game character.

8. The computer implemented game according to claim 1 wherein said computing system under control of said program interrogates said card reader to verify the connection of said card reader to said computing systems.

9. The computer implemented game according to claim 1 wherein said computing system recovers data from said smart card which represents a game playing level of said character.

10. The computer implemented game according to claim 1 wherein said smart card provides said game playing program with additional playing features for said game.

11. A computer implemented game comprising:
a smart card containing an electronic address of a remote computing system containing computer code necessary for playing a computer game;
a smart card reader for receiving said smart card; and
a computer system connected to said smart card reader for playing a game, said computer system executing computer code in response to a user selection made through a graphical interface of said computer system, said computer code including instructions for obtaining the electronic address from said smart card of a remote computer containing related game playing computer code; said computer system including a browser application responsive to said user selection for accessing said remote computer using said electronic address.

12. The computer implemented game according to claim 11 wherein said computer code determines if said smart card is in said reader before attempting to read said smart card.

13. The computer implemented game according to claim 111 wherein said computer code constitutes a browser plug in which is activated through said graphical interface to read said address from said smart card.

14. The computer implemented game according to claim 11 wherein said computer code is stored on a web site and is downloaded from said web site to said computer system.

15. A computer implemented game comprising:
a smart card containing data identifying an electronic address of a remote computing system containing computer code necessary for playing a computer game, or information identifying a program to be run on a computer system;
a smart card reader for receiving said smart card; and
a computer system connected to said smart card reader and to a network connected to said remote computing system, said computer system for playing a game, said computer system executing said computer code in response to a user selection made through a graphical interface, said computer code including instructions for reading said information from said smart card and accessing said remote computing system, and for executing said program identified by said smart card data.

16. The computer implemented game according to claim 15 wherein said computer system includes instructions for:
determining if said program is present in said computing system and, if not;
accessing said remote computing system and downloading said program to said computer system; and
executing said program on said computing system.

17. The computer implemented game according to claim 16, further comprising:
computer code instructions which verify that said smart card is compatible with said computer game.

18. The computer implemented game according to claim 17, wherein said computer code instructions open a browser page which points to a website identified from said electronic address stored in said smart card.
